(19) United States
(12) Patent Application Publication
(10) Pub. No.: US 2005/0183567 A1
(43) Pub. Date: Aug. 25, 2005

(54) Playing motion capturing apparatus, fingering analysis apparatus, string instrument for playing motion capturing, and string instrument for practicing fingering

(76) Inventors: Naofumi Aoki, Sapporo-shi (JP); Shin Tanahashi, Sapporo-shi (JP); Eiichi Kishimoto, Sapporo-shi (JP); Seiki Yasuda, Sapporo-shi (JP); Mutsurou Iwakoshi, Sapporo-shi (JP)

Correspondence Address: JOHN S. PRATT, ESQ;KILPATRICK STOCKTON, LLP, 1100 PEACHTREE STREET, ATLANTA, GA, 30309, US

(21) Appl. No.: 10/812,462

(22) Filed: Mar. 30, 2004

(30) Foreign Application Priority Data
Feb. 20, 2004 (JP) P2004-45250

(51) Int. Cl. G10H 1/18

(52) U.S. Cl. 84/722

(57) ABSTRACT

A playing motion capturing apparatus includes a guitar, a photoreflector, a controller, a piezoelectric pickup, and a personal computer. The photoreflector includes a plurality of full-color LEDs and a plurality of phototransisters, and is disposed in a fingerboard region of the guitar. The photoreflector detects a color of a finger pressing a string, and outputs a position of the finger. The controller turns the full-color LEDs on and off, and outputs light receiving signals of and position information on the phototransister to the personal computer. The piezoelectric pickup detects vibration of the strings and outputs vibration signals to the personal computer.

### CROSS REFERENCE TO RELATED APPLICATION

This application claims benefit of priority under 35 U.S.C. § 119 to Japanese Patent Application No. 2004-45250 filed on Feb. 20, 2004, the entire contents of which are incorporated by reference herein.

### BACKGROUND OF THE INVENTION

1. Field of the Invention

The present invention relates to a playing motion capturing apparatus, a fingering analysis apparatus and a string instrument for playing motion capturing which are employed to create a tab score of a string instrument play. The present invention also relates to a string instrument for practicing fingering.

2. Description of the Related Art

When creating a tab score of the guitar, it is necessary to capture fingering of an experienced player and write down the fingering for pressing a string on a fret on a tab score. A method for capturing player's fingering is disclosed in Japanese Patent Provisional Publication No. 11-85145. In this method, the fingering is captured by means of a data glove. However, if the player plays the guitar with the data glove, the player cannot play in a natural manner because motion ranges of fingers are restricted. Therefore, the method is not satisfactory as the method for capturing fingering.

To solve the above problem, there is a method called optical motion capturing which does not restrict the motion ranges of fingers. In the optical motion capturing, player's fingering is filmed with a video camera, and then positions of the fingers are detected from the filmed image (primary information). However, the following problem arises when this technique is applied to creation of a tab score. Even if the fingering is filmed with the video camera from an appropriate angle, fingers may overlap when a plurality of adjacent strings are pressed by a plurality of fingers at the same time. In this case, it is sometimes impossible to clearly identify which position on which string is pressed by the hidden finger. In other words, an occlusion inevitably occurs. Therefore, it is difficult to accurately capture player's fingering.

### SUMMARY OF THE INVENTION

The present invention has been made in consideration of the above-described technical problem of the related art. An object of the present invention is to provide a playing motion capturing apparatus which is capable of capturing player's fingering automatically and accurately without restricting motion ranges of fingers of the player.

Another object of the present invention is to provide a fingering analysis apparatus which is capable of capturing player's fingering automatically and accurately without restricting motion ranges of fingers of the player, of automatically identifying pressing fingers and identifying strings and frets pressed by the fingers, and of automatically creating a tab score.

Still another object of the present invention is to provide a string instrument for playing motion capturing which is employed to perform playing motion capturing.

Yet another object of the present invention is to provide a string instrument for practicing fingering which is capable of reproducing fingering information obtained by playing motion capturing and allowing a user to practice the fingering.

To attain the object, the present invention provides a playing motion capturing apparatus, comprising: a photoreflector disposed in a position on a string instrument where a player presses strings with fingers, the photoreflector including a plurality of light emitting elements and a plurality of light receiving elements; a light emitting element driving unit which turns the respective light emitting elements on and off; a light receiving signal processing unit which outputs a light receiving signals of the light receiving elements and an identification number of the light receiving element; a string vibration detecting unit which detects vibrations of the strings; and a fingering information obtaining unit which obtains a vibration signal from the string vibration detecting unit, and the light receiving signal and the identification number from the light receiving signal processing unit.

According to the present invention, it is possible to perform capturing of fingering of a player automatically and accurately using the light emitting elements, the light receiving elements, and the string vibration detecting unit without restricting motion ranges of fingers of the player.

To attain the object, the present invention provides a fingering analysis apparatus, comprising: a receiving unit which receives a vibration signal of each string of a string instrument and identification numbers and light receiving signals of a plurality of light receiving elements along a time series; a light receiving element number discriminating unit which discriminates the identification number of the light receiving element that outputs a light receiving amount equal to or greater than a predetermined amount based on the light receiving signal from the receiving unit when the vibration signal exceeds a predetermined value; a finger position identifying unit which judges a position of a pressing finger from the identification number of the discriminated light receiving element; and a fingering information saving unit which saves a result of judgment by the finger position identifying unit along the time series.

According to the present invention, it is possible to analyze positions of fingers pressing strings by capturing fingering of a player automatically and accurately using the vibration signal and the light receiving signal without restricting motion ranges of the fingers of the player.

To attain the object, the present invention provides a fingering analysis apparatus, comprising: a receiving unit which receives a vibration signal of each string of a string instrument and identification numbers and light receiving signals of a plurality of light receiving elements along a time series; a finger number judging unit which performs color identification of a finger pressing the string based on the light receiving signal from the receiving unit when the vibration signal exceeds a predetermined value, and judges a finger number of the pressing finger from preset color-to-finger-number information; a finger position identifying unit which judges a position of the pressing finger from a coordinate position of a photoreflector detecting the finger number; and a fingering information saving unit which saves the finger number and the position of the pressing finger along the time series.

According to the present invention, it is possible to identify fingers pressing strings and to analyze positions thereof by capturing fingering of a player automatically and accurately using the vibration signal and the light receiving signal without restricting motion ranges of the fingers of the player.

To attain the object, the present invention provides a string instrument for playing motion capturing, comprising: a photoreflector disposed in a position on a string instrument where a player presses strings with fingers, the photoreflector including a plurality of light emitting elements and a plurality of light receiving elements; and a string vibration detecting unit which detects vibrations of the plurality of strings.

According to the present invention, this string instrument includes the photoreflector and the string vibration detecting unit and is therefore applicable to playing motion capturing.

To attain the object, the present invention provides a string instrument for practicing fingering, comprising: light emitting elements disposed in a position where a player presses strings with fingers, the light emitting elements emitting red, green and blue light; a light emitting element driving unit which turns the light emitting elements on and off; and an interface which inputs a turn-on instruction and a turn-off instruction for the light emitting elements to the light emitting element driving unit.

According to the present invention, this string instrument includes the light emitting elements, the light emitting element driving unit, and the interface, and is therefore applicable to a fingering practice by reproducing fingering information collected in the course of playing motion capturing.

### BRIEF DESCRIPTION OF THE DRAWINGS

FIG. 1 is a functional block diagram of a playing motion capturing apparatus for a string instrument according to a first embodiment of the present invention.

FIG. 2 is a layout diagram of full-color light emitting diodes (LEDs) and phototransistors arranged on a fingerboard of a guitar according to the first embodiment of the present invention.

FIG. 3 is a block diagram showing a hardware configuration of a photoreflector according to the first embodiment of the present invention.

FIG. 4 is an explanatory view of a light emitting and light receiving mechanism of the photoreflector according to the first embodiment of the present invention.

FIG. 5 is an explanatory view showing a light receiving operation of the phototransistors at light emission timing performed by the full-color LEDs according to the first embodiment of the present invention.

FIG. 6 is an explanatory view showing a light receiving operation of the phototransistors at light non-emission timing performed by the full-color LEDs according to the first embodiment of the present invention.

FIG. 7 is a timing chart of a time-division color information collecting operation performed by the photoreflector according to the first embodiment of the present invention.

FIG. 8 is a block diagram showing a configuration of an analysis apparatus according to the first embodiment of the present invention.

FIG. 9 is a flowchart for creating a tab score according to the first embodiment of the present invention.

FIGS. 10 and 11 are a flowchart for creating a play data according to the first embodiment of the present invention.

FIG. 12 is a flowchart for creating tab score according to the first embodiment of the present invention.

FIG. 13 is a flowchart of a fingering practice process according to a second embodiment of the present invention.

### DESCRIPTION OF THE PREFERRED EMBODIMENTS

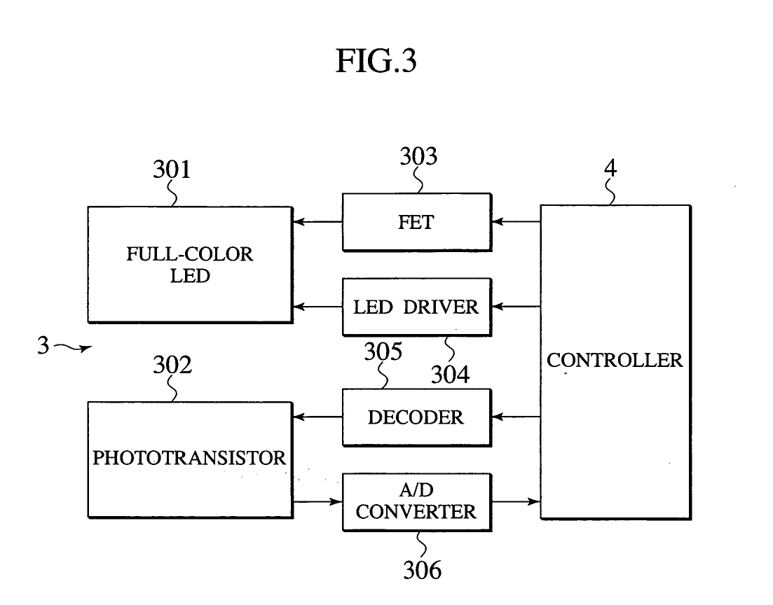

First and second embodiments of the present invention will be detailed with reference to the accompanying drawings. Note that a longitudinal direction and a width direction of a fingerboard region are respectively defined as an X- and Y-axes in FIG. 3.

### First Embodiment

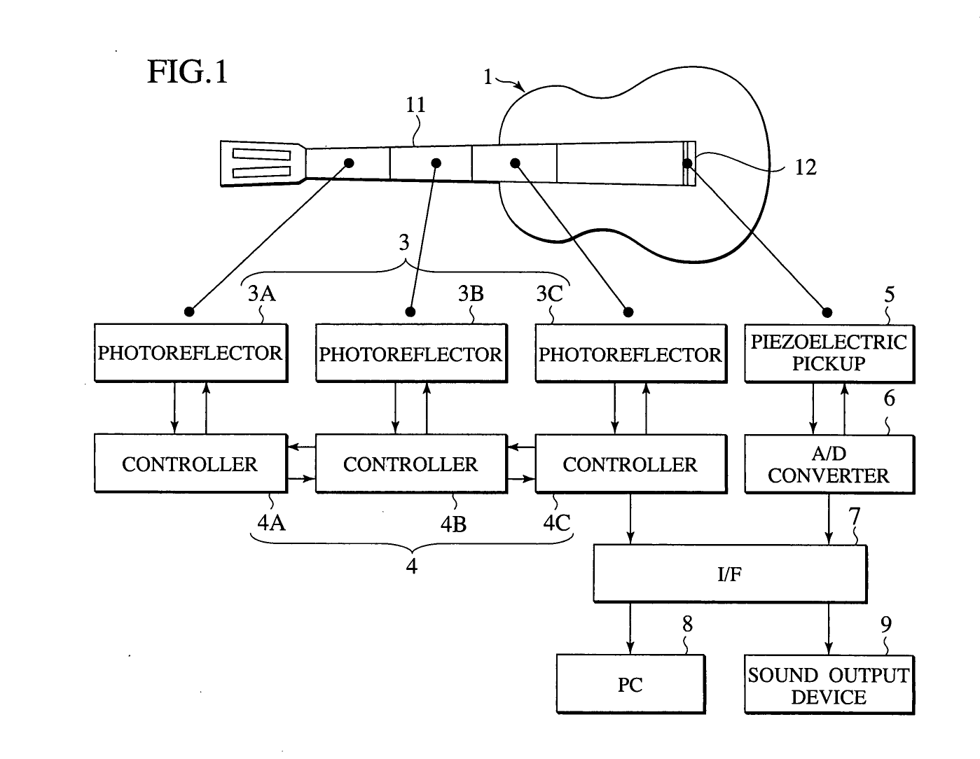

As shown in FIG. 1, a playing motion capturing system includes a guitar (a string instrument for playing motion capturing) 1, photoreflectors 3, controllers 4, piezoelectric pickup 5, an A/D converter 6, an interface (I/F) 7, and a personal computer (an analysis apparatus) 8.

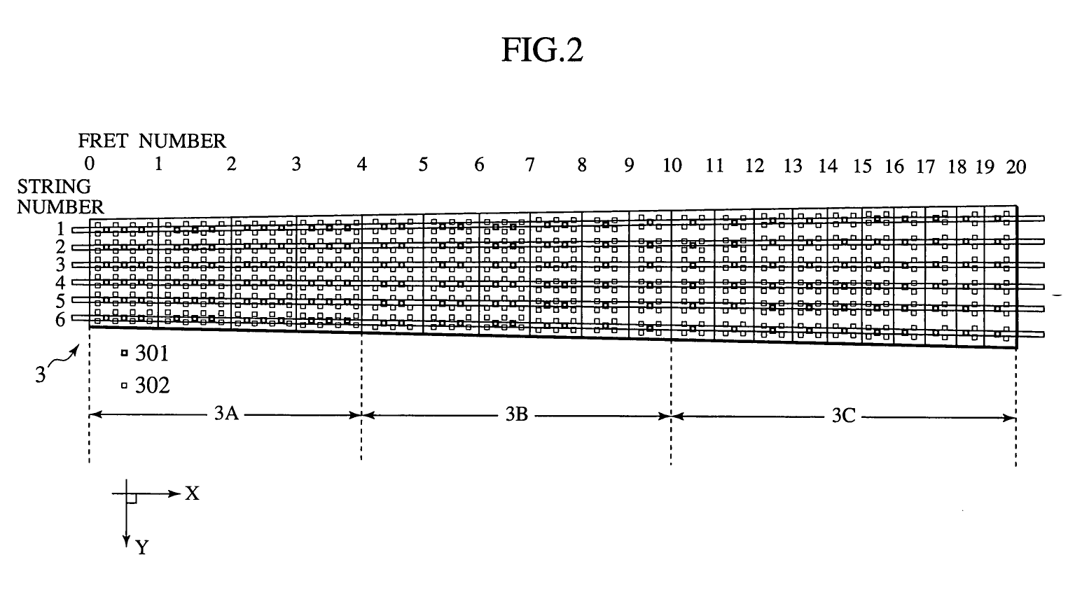

The guitar 1 includes strings, frets and the photoreflectors 3 in a region where a player presses the strings with his/her fingers, that is, in a fingerboard region 11 of a neck of the guitar 1. The guitar 1 makes a specific tone when a player presses the string onto the fret with the left hand and picks the string with the right hand. As shown in FIG. 2, the photoreflector 3 includes full-color LEDs (light emitting elements) 301 and phototransistors (light receiving elements) 302 which are densely arranged on the fingerboard region 11. To capture player's fingering with the photoreflectors 3, each finger is colored differently. As shown in FIG. 1, the fingerboard region 11 is divided into photoreflectors 3A, 3B, and 3C. The controllers 4 include controllers 4A, 4B, and 4C. The controllers 4A, 4B, and 4C are connected to the photoreflectors 3A, 3B, and 3C, respectively. The controllers 4A, 4B, and 4C respectively control light emission cycles of the full-color LEDs 301 and light reception cycles of the phototransistors 302 all of which are provided on the photoreflectors 3A, 3B and 3C. The piezoelectric pickup 5 is disposed on a bridge 12 of the guitar 1 to detect the vibration frequency of the respective strings.

As shown in FIG. 2, in the fingerboard region 11, respective frets extend in the Y direction and are disposed mutually in parallel in the X direction. In this embodiment, the number of frets is set to 20. Note that a fret number 0 corresponds to a nut which is located at a boundary between a head and the neck. The full-color LEDs 301 and the phototransistors 302 are alternately disposed on the fingerboard region 11 as follows. In each space between the adjacent frets, six full-color LEDs 301 are provided along the Y direction in each column and twelve phototransistors 302 are provided along the Y direction in each column. The full-color LEDs 301 are provided in three columns along the X direction in each of spaces between the adjacent frets from the fret number 0 to 4, and the phototransistors 302 are provided in four columns along the X direction therein. In each space between the adjacent frets from the fret numbers 4 to 8, the full-color LEDs 301 are provided in two columns along the X direction and the phototransistors 302 are provided in three columns along the X direction. In each space between the adjacent frets from the fret numbers 8 to 16, the full-color LEDs 301 are provided in one column along the X direction and the phototransistors 302 are provided in two columns along the X direction. In each space between the adjacent frets from the fret numbers 16 to 20, the full-color LEDs 301 and the phototransistors 302 are respectively provided in one column along the X direction. Moreover, in terms of every space between the adjacent frets, an interval between full-color LED 301 and phototransistor 302 and an interval between fret and phototransistor 302 are equal.

In the fingerboard region 11, respective strings are strained along the X direction above the frets, and are disposed mutually in parallel in the Y direction. There are six strings in this embodiment. A first string is strained on a −Y side and a sixth string is strained on a +Y side. In the vicinity of a lower part of each string, there are two full-color LEDs 301 and one phototransistor 302 of each column.

The photoreflectors 3A, 3B, and 3C correspond to a region of the fret numbers 0 to 4, a region of the fret numbers 4 to 10, and a region of the fret numbers 10 to 20, respectively. Due to such division, each of the photoreflectors 3A, 3B, and 3C includes sixteen columns of the phototransistors 302.

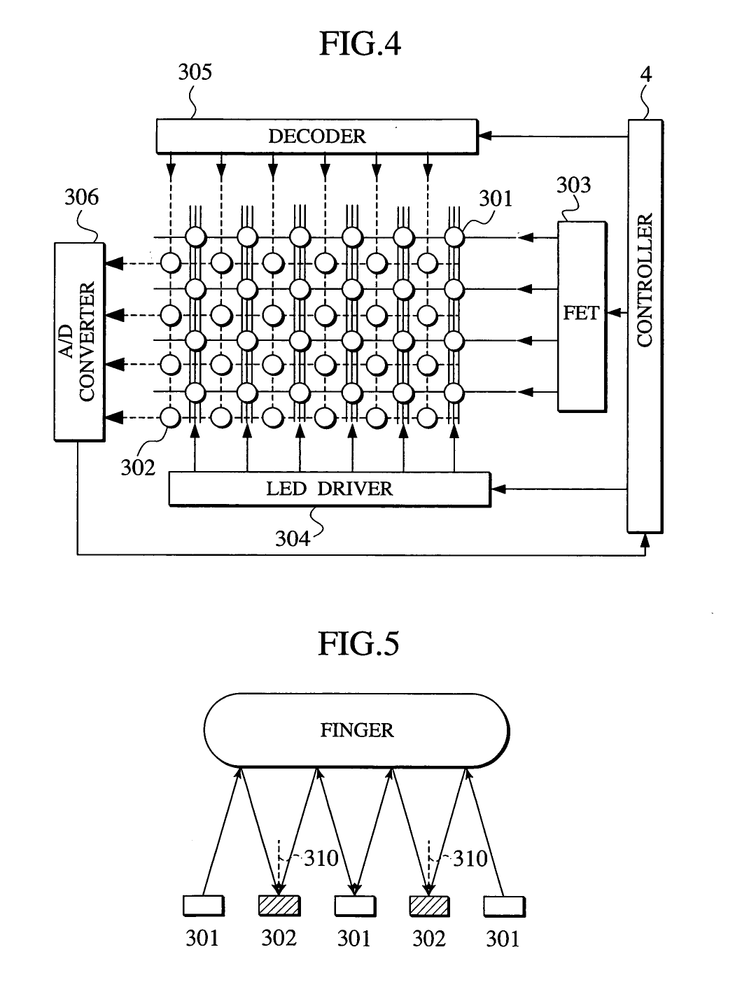

As shown in FIGS. 3 and 4, the controller 4 controls an FET 303 and an LED driver 304 to cause the full-color LEDs 301 to emit light in a fast cycle. In this event, the full-color LEDs 301 simultaneously emit the same color throughout the fingerboard region 11 in the order of red (R), green (G), and blue (B). It is to be noted, however, that the order of the colors emitted by the full-color LEDs 301 is not limited to the foregoing.

The light emission cycle of the full-color LEDs 301 is determined based on the tempo of a musical piece and on minimum note information. Here, the minimum note information represents the shortest note among the notes in the musical piece. The tempo is usually defined as the information representing how many quarter notes are played in one minute. In addition to quarter notes, the notes include half notes, eighth notes, sixteenth notes, thirty-second notes, sixty-fourth notes and the like. Meanwhile, the full-color LED 301 emits the light in a set of three colors. In consideration thereof, it is necessary to cause the full-color LEDs 301 to emit light in a cycle (s) of 60/{3×tempo×(minimum note information/4)} in order to create an accurate tab score.

The controller 4 controls a decoder 305 to allow the phototransistors 302 to receive light synchronously with a half of the cycle of the full-color LEDs 301. As described later, the phototransistor 302 detects a light receiving amount while light is on and a light receiving amount while light is off in each color of the full-color LED 301. Accordingly, the cycle of the phototransistor 302 is set to the half of the cycle of the full-color LED 301. Then, the controller 4 receives light receiving signals and position information from the phototransistors 302 through an A/D converter 306. The light receiving signal is obtained by converting a light receiving amount detected by the phototransistor 302 into an electric signal. The position information is a coordinate value of the phototransistor 302 in the fingerboard region 11. The phototransistor 302 outputs the position information only when the full-color LED 301 is lit. The A/D converter 306 performs A/D conversion of the light receiving signals from the phototransistors 302. The number of the A/D converters 306 is fewer than the number of the phototransistors 302. Therefore, the controller 4 controls the decoder 305 in every predetermined cycle so as to set the phototransistors 302 in the same number as the number of the A/D converters 306 to a light receiving state. In this way, the A/D converters 306 correspond one by one to the phototransistors 302. The A/D converters 306 are efficiently used by time-division control of the controller 4. Alternatively, it is possible to provide the A/D converters 306 in the same number as the number of the phototransistors 302.

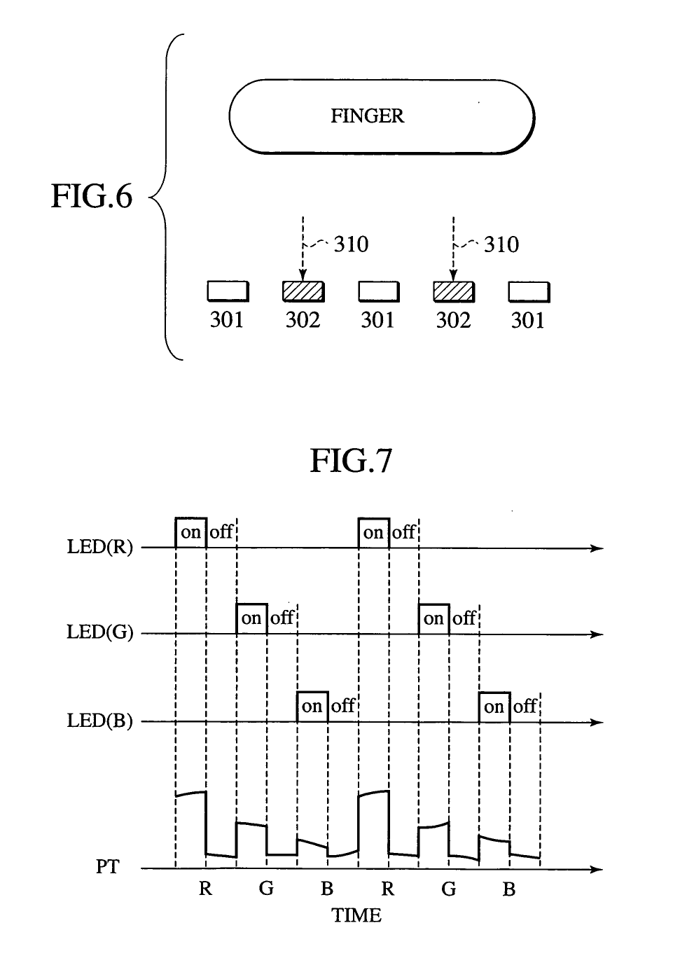

As shown in FIG. 5, when the full-color LEDs 301 emit a certain color in the photoreflector 3, the phototransistors 302 adjacent to the full-color LED 301 receive reflected light which is generated by player's fingers which reflect the light. In this way, the phototransistors 302 output the light receiving signals. However, as shown in FIG. 6, when the full-color LEDs 301 are not lit, light from a light source other than the full-color LEDs 301 is received by the phototransistors 302 as a background noise 310. The background noise 310 is also received by the phototransistors 302 during emission of the full-color LEDs 301. For this reason, it is necessary to discriminate the background noise 310 from the reflected light generated by the fingers.

The controller 4 causes the full-color LEDs 301 alternately turn light on and off in the fast cycle, and outputs to the personal computer 8 as the light receiving signals the light receiving amounts while light is on and the light receiving amount while light is off in the phototransistors 302. When detecting the light receiving signals, the personal computer 8 calculates differences between the light receiving amounts while light is on and the light receiving amounts while light is off in the phototransistors 302 in each color of the full-color LEDs 301. In a fingering analysis process, if a differential light receiving amount equal to or greater than a predetermined value is obtained, the personal computer 8 judges receipt of the reflected light from either the finger colored in the same color as the color emitted by the full-color LEDs 301 or the finger colored in the color containing the color emitted by the full-color LEDs 301. Here, to identify the fingers which press the strings, the respective fingers on the left hand are colored in mutually different colors. For example, when four fingers are used, red (R), green (G), blue (B), and white (W) are respectively applied to the four fingers. When five fingers are used, red (R), green (G), blue (B), white (W), and a neutral color are respectively applied thereto. In this state, when the full-color LEDs 301 emits red light, for example, the personal computer 8 judges that either the finger colored in red or the finger colored in the color containing red is pressing the string when the differential light receiving amount equal to or greater than the predetermined amount is calculated. In this way, the pressing finger is identified (see FIG. 7).

Moreover, the controller 4 outputs the position information on the phototransistor 302 receiving the light, which is allocated based on 48×12 coordinate values set on the fingerboard region 11, together with the light receiving signals to the personal computer 8. In the fingering analysis process, when the differential light receiving amount equal to or greater than the predetermined value is obtained, the personal computer 8 identifies the string number and the fret number pressed by the finger based on the position information on the relevant phototransistor 302.

A correspondence between the coordinate value of the phototransistor 302 and the string number is described as g=[(y+1)/2], where y is a y component of the coordinate value of the phototransistor 302 and g is the string number. Meanwhile, a correspondence between the coordinate value of the phototransistor 302 and the fret number is as follows. In terms of the fret numbers 0 to 4, mod(x/4) is calculated. The coordinate value corresponds to a [(x−1)/4]-th fret when mod=1 or 2, and to a {[(x−1)/4]+1}-th fret when mod=0 or 3. Here, [ ] is a Gauss code. In terms of the fret numbers 4 to 8, mod{(x−16)/3} is calculated. The coordinate value corresponds to a {[(x−17)/3]+4}-th fret when mod=1 or 2, and to a {([(x−17)/3]+5)-th fret when the mod=0. In terms of the fret numbers 8 to 16, mod(x/2) is calculated. The coordinate value corresponds to a ([(x−29)/2]+8)-th fret when mod=1, and to a {([(x−29)/2]+9}-th fret when mod=0. In terms of the fret numbers 17 to 20, the coordinate value corresponds to a (x−28)-th fret.

The piezoelectric pickup 5 converts a vibration frequency of each string into an electric signal and outputs the vibration frequency of the string to the personal computer 8 as a vibration signal with the output of the position information from the phototransistor 302 synchronously. The vibration signal from the piezoelectric pickup 5 is subjected to A/D conversion by the A/D converter 6 and is outputted to the personal computer 8 through the interface 7. In the fingering analysis process, the personal computer 8 judges that the player picked the string when the vibration frequency is detected. The personal computer 8 is triggered by this judge to identify the pressing finger, the string number and the fret number pressed by the finger, based on the differential light receiving amount and the position information.

Moreover, in order to improve reliability of the string number and the fret number which are detected from the differential light receiving amount and the position information, the personal computer 8 obtains the string number and the fret number based on the vibration signal from the piezoelectric pickup 5 and certifies as to whether the former string number and fret number are the same as the latter string number and fret number.

Although the type of the interface 7 is not particularly limited, a USB interface is used in this embodiment.

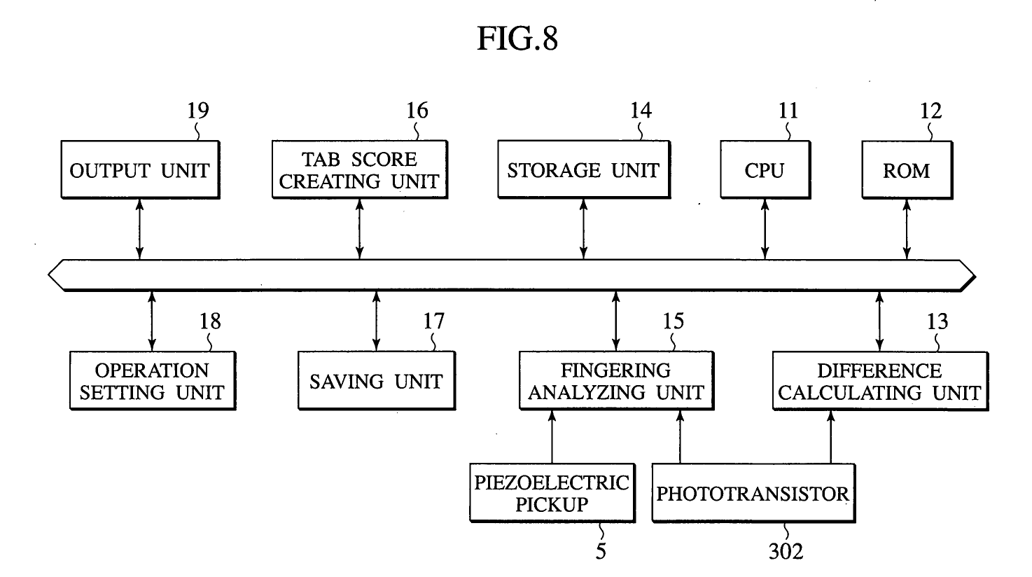

As shown in FIG. 8, the personal computer 8 includes a CPU 11, a ROM 12, a difference calculating unit 13, a storage unit 14, a fingering analyzing unit 15, a tab score creating unit 16, a saving unit 17, an operation setting unit 18 and an output unit 19. The CPU 11 controls the entire personal computer 8 and is connected to the ROM 12, the difference calculating unit 13, the storage unit 14, the fingering analyzing unit 15, the tab score creating unit 16, the saving unit 17, the operation setting unit 18, and the output unit 19 through a bus.

The ROM 12 stores a program for controlling the CPU 11. The difference calculating unit 13 obtains the light receiving signal from the phototransistor 302 and then calculates the difference between the light receiving amount while light is on and the light receiving amount while light is off in each color of the full-color LED 301. The storage unit 14 stores various information used for the fingering analysis and score creation in advance. The fingering analyzing unit 15 receives the signal detected by the phototransistor 302 and the signal detected by the piezoelectric pickup 5, and creates play data. The tab score creating unit 16 extracts necessary information for creating tab score data out of the play data created by the fingering analyzing unit 15, and creates the tab score data by use of staff notation display data, note data, font data and the like which are stored in the storage unit 14. The saving unit 17 stores the play data and the tab score data thus created. The operation setting unit 18 includes an operation panel, a numeric key pad and the like, and performs various operations and settings. The output unit 19 outputs the created tab score data.

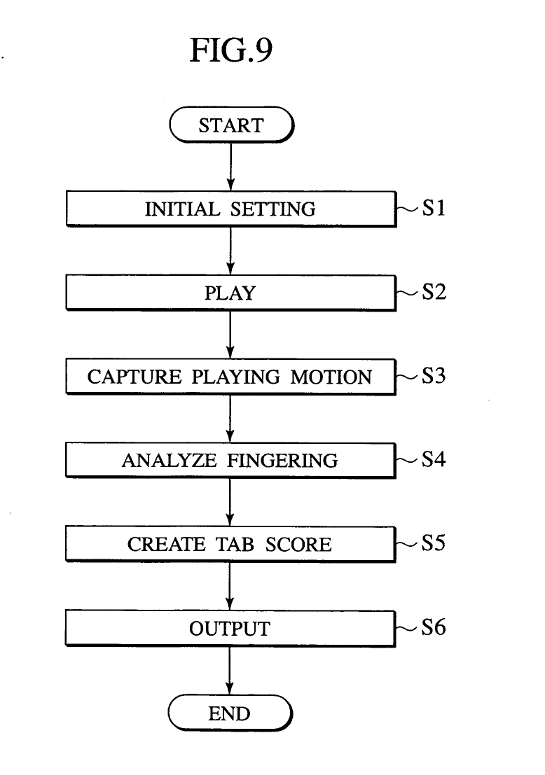

In order to create a tab score, the personal computer 8 executes a process described in a flowchart of FIG. 9, based on the differential light receiving amounts, the position information and the vibration signals.

Firstly, initial setting of the personal computer 8 is performed by use of the operation setting unit 18 (Step S1). In the initial setting, vibration frequencies of the respective open strings, the number of frets, the beat of the musical piece, the tempo of the musical piece, the minimum note information and the like are inputted. By inputting the vibration frequencies of the respective open strings, it is possible to identify the fret pressed by the finger from the vibration frequency of the string. By inputting the number of frets, the sound range which the string can make is determined. By inputting the beat (such as four-quarter time) of the musical piece, reference for arranging bar lines and notes upon creation of the tab score are determined. By inputting the tempo and the minimum note information on the musical piece, the light emission cycle of the full-color LEDs 301 and the light reception cycle of the phototransistors 302 are determined.

After completing the initial setting, initial setting items are transferred to the fingering analyzing unit 15. Next, respective fingers of the left hand of the player are colored differently, and then the player starts playing the guitar 1 (Step S2). Simultaneously with the play by the player, the playing motion capturing system is started (Step S3). In Step S3, the controller 4 allows the full-color LEDs 301 to emit the light in the order of red (R), green (G), and blue (B) in the fast cycle. The phototransistors 302 output the light receiving signals (the light receiving amounts while light is on and the light receiving amounts while light is off in each color) and the position information to the controller 4 synchronously with the light emission cycle of the full-color LEDs 301. The controller 4 outputs the light receiving signals to the difference calculating unit 13 of the personal computer 8 through the interface 7, and also outputs the position information on the phototransistor 302 receiving the light to the fingering analyzing unit 15 of the personal computer 8 through the interface 7. When the difference calculating unit 13 obtains the light receiving signals from the controller 4, calculates the differential light receiving amounts between the light receiving amounts while light is on and the light receiving amounts while light is off in each color of the full-color LEDs 301, and outputs the differential light receiving amounts to the fingering analyzing unit 15 through the bus.

Meanwhile, the piezoelectric pickup 5 converts the vibration frequencies of the strings into the electric signals, and outputs the electric signals as the vibration signals synchronously with the output of the controller 4 to the fingering analyzing unit 15 of the personal computer 8 through the A/D converter 6 and the interface 7. Such capturing of a playing motion continues until the play finishes.

The fingering analyzing unit 15 creates the play data based on the differential light receiving amounts, the position information and the vibration signals (Step S4), and saves the play data in the saving unit 17. The tab score creating unit 16 extracts various information from the play data, and creates the tab score data (Step S5). The tab score data are saved in the saving unit 17 and are outputted to the output unit 19 (Step S6).

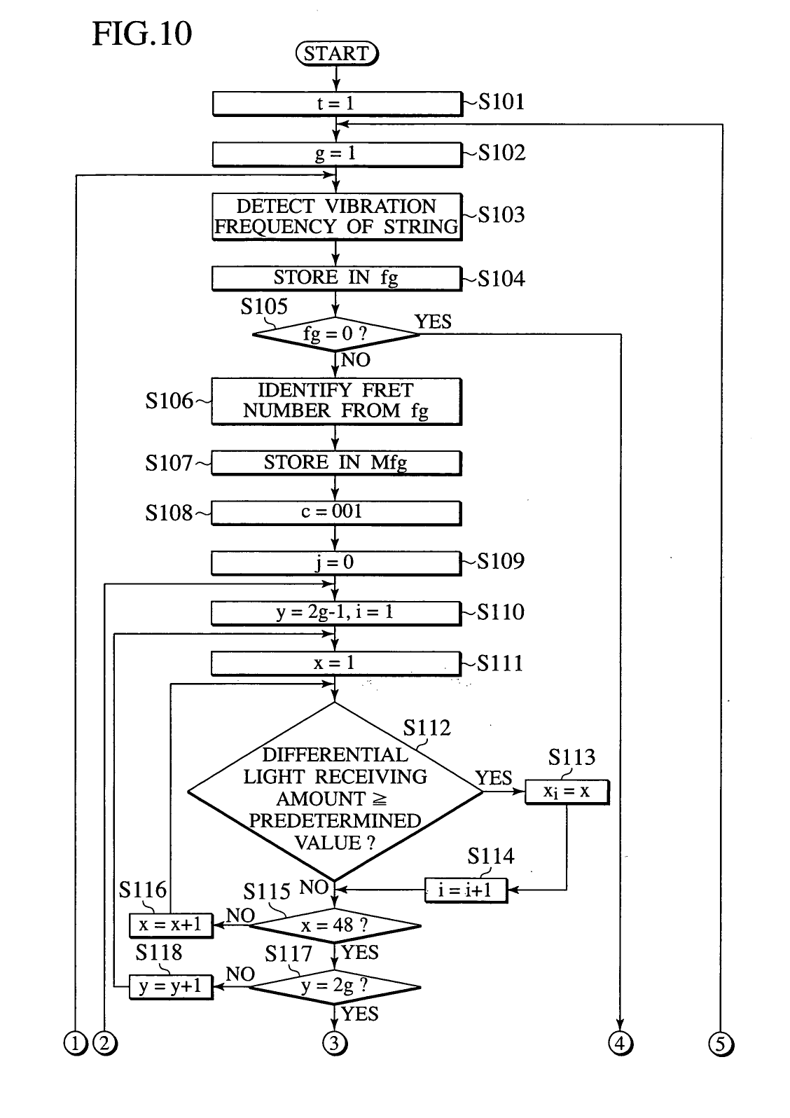

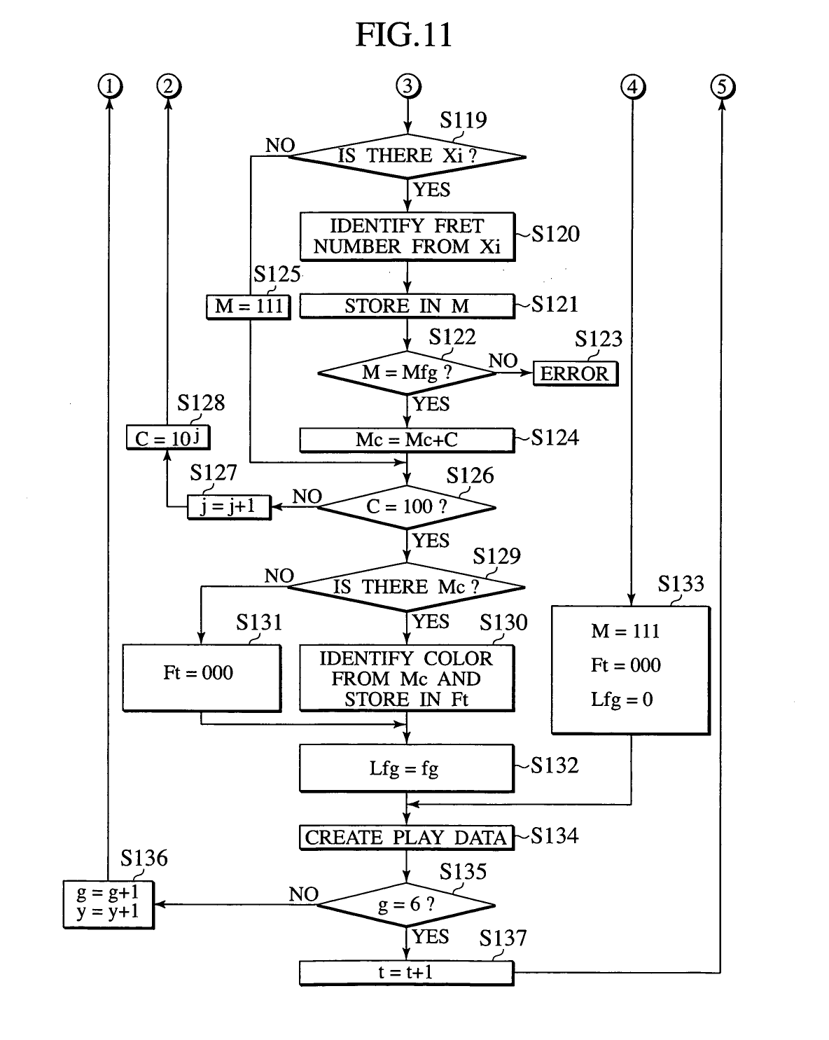

Next, a play data creation process will be described with reference to FIGS. 10 and 11. The fingering analyzing unit 15 has the differential light receiving amounts and the position information in terms of the phototransistors 302 (48×12 pieces), and the vibration frequencies of the strings (6 lines) in each time period.

When the fingering analysis is started, a first-round process is executed. Here, t is set equal to 1 (Step S101), and g is set equal to 1 (Step S102) to detect whether or not the first string is picked by the finger. Thereafter, the tone is calculated by the vibration frequency of the g-th string (Step S103), and the tone is stored in a variable fg indicating the tone of the g-th string (Step S104). The tone is calculated directly from the vibration frequency of the string based on the vibration frequency of the open string which has been initially set.

Next, judgment is made as to whether the vibration frequency of the g-th string is 0 (Step S105). When the vibration frequency of the g-th string is not 0, the fret number pressed by the finger is identified based on the tone of the g-th string stored in the variable fg (Step S106), and the identified fret number is stored in a variable Mfg indicating the fret number of the g-th string (Step S107).

Next, the color of the finger pressing the string is identified. Here, to recognize the respective colors, color numbers of 001, 010, and 100 are allocated in advance to red (R), green (G), and blue (B), respectively. In this way, it is possible to express neutral colors, namely, yellow (Y=R(001)+G(010)), magenta (M=R(001)+B(100)), cyan (C=G(010)+B(100)) and white (W=R(001)+G(010)+B(100)) by the color numbers 011, 101, 110 and 111, respectively. In the first place, c is set to 001 (Step S108) to identify whether the color is red (R) or not, and a variable j for updating the color number is initialized to j=0 (Step S109). Then, a y component of the coordinate value of the phototransistor 302 is initialized to y=2g−1 and a suffix of a variable Xi for storing an x coordinate of the phototransistor 302, which detects the differential light receiving amount equal to or greater than the predetermined value, is initialized to i=1, respectively (Step S110). Moreover, an x component of the coordinate value of the phototransistor 302 is initialized to x=1 (Step S111). Note that the phototransistors 302 to be disposed in the vicinity of a lower part of the g-th string apply the coordinate values of (x, 2g−1) and (x, 2g) (see FIG. 3).

When the initialization of the respective variables is finished, judgment is made as to whether the differential light receiving amount is equal to or greater than the predetermined value (Step S112). When the differential light receiving amount is equal to or greater than the predetermined value, the x component of the coordinate value of the phototransistor 302 from which this light receiving amount is detected is stored in the variable Xi (Step S113), then 1 is added to the i value (Step S114), and then the process moves to Step S115. When the differential light receiving amount is not equal to or greater than the predetermined value, the process moves to Step S115. Thereafter, judgment is made as to whether the x component of the coordinate value of the phototransistor 302 from which the light is detected is equal to 48 (Step S115). When the x component of the coordinate value is not equal to 48, 1 is added to the x value (Step S116), and the process returns to Step S112. When the x component of the coordinate value is equal to 48, judgment is made as to whether the y component of the coordinate value is equal to 2g or not (Step S117). When the y component of the coordinate value is not equal to 2g, 1 is added to the y value (Step S118), and the process returns to Step S111. When the y component of the coordinate value is equal to 2g, judgment is made as to whether there is the variable Xi (Step S119). When there is the variable Xi, one fret number is calculated from the x value stored in the variable Xi (Step S120), and the fret number is stored in a variable M (Step S121).

Next, to improve reliability of the identified fret number, judgment is made as to whether the fret number stored in the variable M is the same as the fret number stored in the variable Mfg (Step S122). When the fret numbers are not the same, an indicator “ERROR” is displayed on a monitor of the output unit 19 (Step S123). When the fret numbers are the same, the value of the color number c is stored in a variable Mc (Step S124), and then the process moves to Step S126. In Step S119, when there is not the variable Xi, the fret number 111 is stored in the variable M (Step S125), and then the process moves to Step S126. The fret number 111 shows that there is not a fret on which finger does not press the g-th string.

Next, judgment is made as to whether the value of the color number c is equal to 100 (Step S126). When the value of the color number c is not equal to 100, 1 is added to the j value (Step S127) to change the color number c to c=10^{j} (Step S128). Then the process returns to Step S110.

When the value of the color number is equal to 100, judgment is made as to whether there is the variable Mc (Step S129). When there is the variable Mc, the color applied on the finger pressing the string is identified from the value stored in the variable Mc and the color number is stored in a variable Ft (Step S130). Thereafter, the process moves to Step S132. When there is not the variable Mc, the color number 000 is stored in the variable Ft (Step S131), and the process moves to Step S132. The color number 000 shows that finger does not press the g-th string on any fret. Next, the variable fg is stored in a variable Lfg (Step S132). Then, the process moves to Step S134.

In Step S105, when the vibration frequency of the g-th string is equal to 0, the process moves to Step S133. Next, the fret number 111, the color number 000 and the vibration frequency 0 are stored in the variable M, Ft and Lfg, respectively (Step S133). Then, the process moves to Step S134.

Next, to create the play data in the first-round process, the following is outputted in a lump as a data group of the first-round process to the saving unit 17 (Step S134): the pressing finger from the color number stored in the variable Ft; the string number from the g value; the fret number from the value stored in the variable M; and the tone from the value stored in the variable Lfg. Thereafter, judgment is made as to whether the g value is equal to 6 or not (Step S135). When the g value is not equal to 6, 1 is added to the g value and 1 is added to the y value (Step S136), and then the process returns to Step S103. When the g value is equal to 6, 1 is added to the t value (Step S137), and the process returns to Step S102. The above-described series of operations are continued until the play is finished.

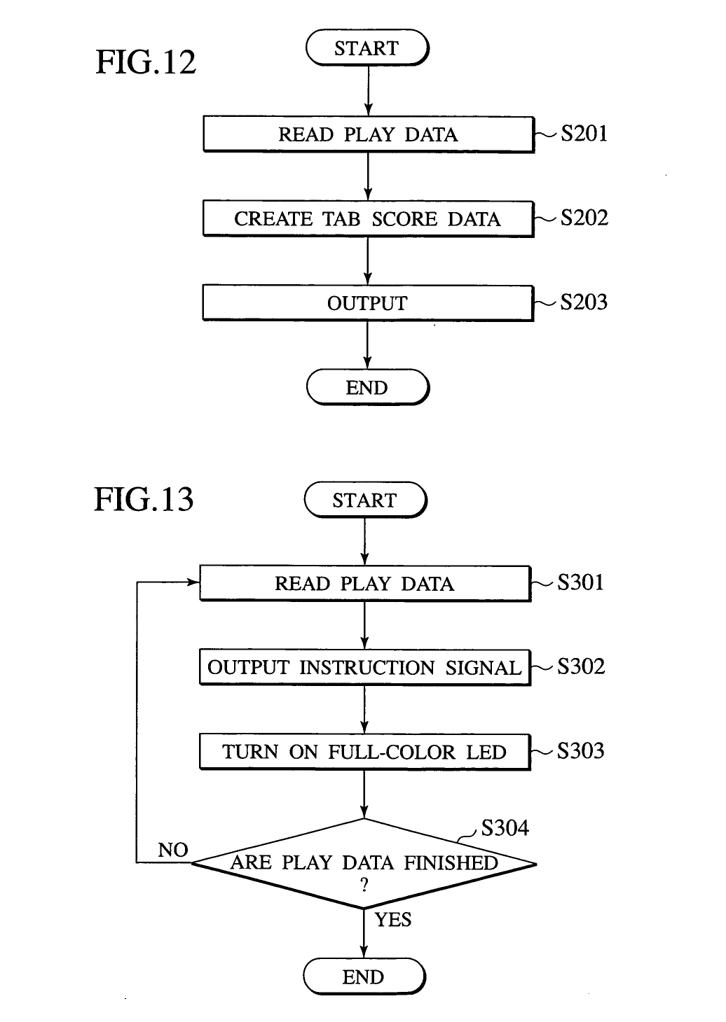

Next, a description will be given of creation of the tab score data with reference to FIG. 12. In the tab score, a tab score is described under the staff notation and the finger numbers are indicated below the tab store.

The tab score creating unit 15 reads the play data out of the saving unit 17 and specifies the notes, the pressing fingers, the string numbers, and the fret numbers (Step S201). Then, based on the specified information, the tab score data are produced by use of the staff notation display data, the note data, the font data and the like stored in the storage unit 14 (Step S202), and the tab score data are outputted to the output unit 19 (Step S203).

In this way, the playing motion capturing apparatus of this embodiment can automatically detect the fingering data when playing the string instrument and accurately analyze the fingering data as well. The playing motion information thus collected is used for producing the tab score which designates the pressing fingers and indicates the positions to press the specific string on the specific fret.

It is possible to automatically play the guitar based on the fingering data recorded in the personal computer 8.

Note that this embodiment has been described on the guitar as an example of the string instrument. However, the string instrument is not limited thereto. It is possible to automatically detect fingering data of an experienced player and to accurately analyze the fingering data similarly to the above case in cases of other string instruments including the violin, the viola, and the like.

### Second Embodiment

A fingering practicing system allows a user to practice fingering by reproducing play data collected by playing motion capturing.

In the fingering practicing system, the string instrument 1 for fingering practice includes the full-color LEDs 301 which are densely arranged on the fingerboard region 11 (see FIGS. 2 and 3). As compared to the arrangement of the photoreflectors 3 in the first embodiment, the phototransistors 302 are not provided here. Therefore, the decoder 305 for driving the phototransistors 302 and the A/D converter 306 are not provided in this embodiment. Moreover, the piezoelectric pickup 5 for outputting the string vibrations and the A/D converter 6 are not provided in this embodiment.

The photoreflector 3 is connected to the controller 4. The controller 4 is connected to the personal computer 8 through the interface 7. In this embodiment, the personal computer 8 reproduces the play data saved in advance and outputs the play data to the controller 4. The controller 4 causes the full-color LEDs 301 arranged on the fingerboard region 11 to emit light based on the instrument playing data.

The fingering practicing system executes a process shown in a flowchart of FIG. 13.

In the personal computer 8, when the play data are read (Step S301), the play data are converted into LED coordinates and LED color numbers corresponding to the finger numbers, the fret numbers and the string numbers. Then, the LED coordinates and the LED color numbers are outputted as instruction signals (Step S302). When the instruction signal are received by the controller 4, the LEDs to be lit and the colors to be lit are designated based on the LED coordinates and the LED color numbers. The LED driver 304 turns on the full-color LEDs 301 in accordance with the designations (Step S303). Then, the process from the Steps S301 to S303 is repeated until the play data are finished (Step S304).

In this way, it is easy to indicate the fingers for pressing the string on the fret on the fingerboard region 11 of the guitar 1, along with reproduction of the musical piece by means of the lit colors and lit positions of the corresponding full-color LEDs 301. Accordingly, the learner can practice correct fingering while confirming the lit colors and lit positions of the full-color LEDs 301.

Note that it is possible to treat the guitar 1 as a commodity in the present invention. In this event, it is possible to adopt a configuration in which the photoreflectors 3 are arranged on the fingerboard region 11 of guitar 1 in accordance with the layout shown in FIG. 2 and the piezoelectric pickup 5 is fitted on the bridge 12. Alternatively, a configuration may be adopted in which the controller 4 and the A/D converter 6 are further connected to the foregoing configuration.

Moreover, the string instrument for fingering practice per se can be also treated as a commodity. In such a case, it is possible to arrange the full-color LEDs on the fingerboard region 11 of the guitar 1 in accordance with the above-described layout.

1. A playing motion capturing apparatus, comprising:
a photoreflector disposed in a position on a string instrument where a player presses strings with fingers, the photoreflector including a plurality of light emitting elements and a plurality of light receiving elements;
a light emitting element driving unit which turns the respective light emitting elements on and off;
a light receiving signal processing unit which outputs a light receiving signals of the light receiving elements and an identification number of the light receiving element;
a string vibration detecting unit which detects vibrations of the strings; and
a fingering information obtaining unit which obtains a vibration signal from the string vibration detecting unit, and the light receiving signal and the identification number from the light receiving signal processing unit.

2. The playing motion capturing apparatus according to claim 1, wherein the light emitting elements emit light in a cycle relating to the tempo of a musical piece.

3. The playing motion capturing apparatus according to claim 1, wherein the light receiving elements receive light in a cycle relating to the tempo of a musical piece, the light is emitted by the light emitting element and then reflected by player's finger.

4. The playing motion capturing apparatus according to claim 1, wherein the light emitting element is a light emitting diode which emits red, green, and blue light.

5. The playing motion capturing apparatus according to claim 1, wherein the light receiving element is a phototransistor.

6. The playing motion capturing apparatus according to claim 1, wherein the string vibration detecting unit is a piezoelectric pickup provided at a bridge portion of the string instrument.

7. The playing motion capturing apparatus according to claim 1, wherein the string instrument is a guitar.

8. A fingering analysis apparatus, comprising:
a receiving unit which receives a vibration signal of each string of a string instrument and identification numbers and light receiving signals of a plurality of light receiving elements along a time series;
a light receiving element number discriminating unit which discriminates the identification number of the light receiving element that outputs a light receiving amount equal to or greater than a predetermined amount based on the light receiving signal from the receiving unit when the vibration signal exceeds a predetermined value;
a finger position identifying unit which judges a position of a pressing finger from the identification number of the discriminated light receiving element; and
a fingering information saving unit which saves a result of judgment by the finger position identifying unit along the time series.

9. A fingering analysis apparatus, comprising:
a receiving unit which receives a vibration signal of each string of a string instrument and identification numbers and light receiving signals of a plurality of light receiving elements along a time series;
a finger number judging unit which performs color identification of a finger pressing the string based on the light receiving signal from the receiving unit when the vibration signal exceeds a predetermined value, and judges a finger number of the pressing finger from preset color-to-finger-number information;
a finger position identifying unit which judges a position of the pressing finger from a coordinate position of a photoreflector detecting the finger number; and
a fingering information saving unit which saves the finger number and the position of the pressing finger along the time series.

10. A string instrument for playing motion capturing, comprising:
a photoreflector disposed in a position on a string instrument where a player presses strings with fingers, the photoreflector including a plurality of light emitting elements and a plurality of light receiving elements; and
a string vibration detecting unit which detects vibrations of the plurality of strings.

11. The string instrument for playing motion capturing according to claim 10, wherein the light emitting element is a light emitting diode which emits red, green, and blue light.

12. The string instrument for playing motion capturing according to claim 10, wherein the light receiving element is a phototransistor.

13. The string instrument for playing motion capturing according to claim 10, wherein the string vibration detecting unit is a piezoelectric pickup.

14. A string instrument for practicing fingering, comprising:
light emitting elements disposed in a position where a player presses strings with fingers, the light emitting elements emitting red, green and blue light;
a light emitting element driving unit which turns the light emitting elements on and off; and
an interface which inputs a turn-on instruction and a turn-off instruction for the light emitting elements to the light emitting element driving unit.
